(19) United States
(12) Patent Application Publication
(10) Pub. No.: US 2021/0120385 A1
(43) Pub. Date: Apr. 22, 2021

(54) Vehicle Telematics System Utilizing Prediction Function

(71) Applicant: Robert Bosch GmbH, Stuttgart (DE)

(72) Inventor: Steven Zack, Essex, CT (US)

(21) Appl. No.: 16/658,829

(22) Filed: Oct. 21, 2019

(51) Int. Cl. H04W 4/44; G07C 5/08; G07C 5/00; G05D 1/00; H04L 29/08; H04W 4/021; B60K 35/00

(52) U.S. Cl. CPC H04W 4/44; G07C 5/0808; G07C 5/008; G05D 1/0061; B60K 2370/739; H04L 67/12; H04W 4/021; B60K 35/00; G05D 1/0022

(57) ABSTRACT

A vehicle telematics system operable to assess the operating condition of a vehicle, receive information about assets nearby, and predict a desired transaction for the vehicle at one or mare of the nearby assets. The vehicle telematics system may comprise a processor operable to consult a history of past telematics communications and vehicle operations to make a prediction of a desired transaction.

### TECHNICAL FIELD

This disclosure relates to vehicle telematics and in particular the utilization of vehicle telematics for the purpose of vehicle maintenance.

### BACKGROUND

Vehicle telematics systems may be utilized to present information about nearby vendors of goods or services to a passenger of a vehicle. However, current telematics systems are focused primarily on the desires of a vehicle passenger, rather than operational condition of the vehicle. Furthermore, current telematics systems do not comprise functions to predict the needs of passengers or vehicle based upon an assessment of the operational condition of the vehicle or the desires of the passengers therein.

### SUMMARY

One aspect of this disclosure is directed to a vehicle telematics system comprising a processor, a memory, and a receiver, the memory and receiver being in data communication with the processor. The receiver may be operable to receive wireless communications from an infrastructure data source within a proximity of the receiver. The infrastructure data source may provide data describing available transactions from a vendor that may be useful for the vehicle or a passenger of the vehicle. The memory may be configured to store a record comprising a history of infrastructure communications, and the processor may be operable to predict a desired transaction based upon the record and assessment data describing the operating condition of the vehicle. Some embodiments may further comprise a transmitter operable to wirelessly transmit a vehicle communication to an infrastructure data receiver.

Another aspect of this disclosure is directed to a vehicle telematics system comprising a vehicle having a processor, memory, receiver, and transmitter. The memory, receiver, and transmitter may be in data communication with the processor. The receiver may be operable to receive wireless communications from an infrastructure data source within a proximity of the receiver. The infrastructure data source may provide data describing available transactions from a vendor that may be useful for the vehicle or a passenger of the vehicle. The transmitter may be operable to transmit wireless communications to an infrastructure data receiver, which may correspond to data describing a requested transaction for the vehicle or a passenger of the vehicle. The memory may be configured to store a record comprising a history of infrastructure communications, and the processor may be operable to predict a desired transaction based upon the record and assessment data describing the operating condition of the vehicle.

A further aspect of this disclosure is directed to a vehicle telematics system comprising a processor, a memory, a receiver, a transmitter, and a geolocation sensor, each of the memory, receiver, transmitter, and geolocation sensor being in data communication with the processor. The receiver may be operable to receive wireless communications from an infrastructure data source within a proximity of the receiver. The infrastructure data source may provide data describing available transactions from a vendor that may be useful for the vehicle or a passenger of the vehicle. The transmitter may be operable to transmit wireless communications to an infrastructure data receiver, which may correspond to data describing a requested transaction for the vehicle or a passenger of the vehicle. The geolocation sensor may be operable to generate data indicating a physical location of the vehicle during operation. The memory may be configured to store a record comprising a history of infrastructure communications, and the processor may be operable to predict a desired transaction based upon the record and assessment data describing the operating condition of the vehicle. Sonic embodiments may further comprise a transmitter operable to wirelessly transmit a vehicle communication to an infrastructure data receiver.

The above aspects of this disclosure and other aspects will be explained in greater detail below with reference to the attached drawings.

### BRIEF DESCRIPTION OF THE DRAWINGS

FIG. 1 is a diagrammatic illustration of a vehicle telematics system associated with a vehicle.

FIG. 2 is a diagrammatic illustration of a vehicle telematics system during normal operation.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to sale and some features may be exaggerated or minimized to show details of particular components. The specific structural and functional details disclosed are not to be interpreted as limiting, but as a representative basis for teaching one skilled in the art how to practice the disclosed concepts.

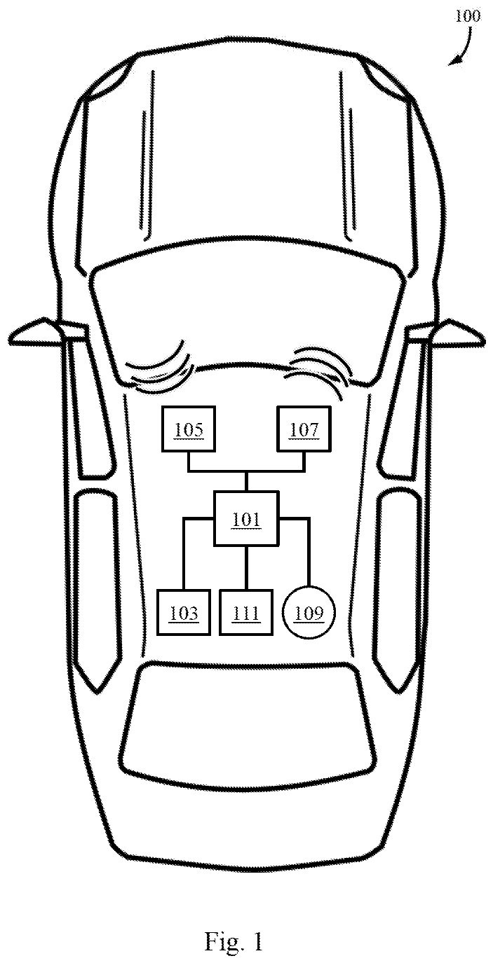

FIG. 1 shows a vehicle telematics system associated with a vehicle 100. The system comprises a processor 101 in data communication with a memory 103, a receiver 105, a transmitter 107, and a geolocation sensor 109. Memory 103 may comprise computer-readable instructions stored thereon that, when read by processor 101, cause processor 101 to execute one or more functions.

Computer-readable instructions may include instructions and data which cause a general purpose computer, special purpose computer, or special purpose processing device to perform a certain function or group of functions. Computer-readable instructions may also include program modules that are executed by computers in stand-alone or network environments. Program modules may include routines, programs, objects, components, or data structures that perform particular tasks or implement particular abstract data types. Computer-readable instructions, associated data structures, and program modules represent examples of the program code means for executing steps of the methods disclosed herein. The particular sequence of such executable instructions or associated data structures represents examples of corresponding acts for implementing the functions described in such steps.

Memory 103 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Receiver 105 and transmitter 107 may be operable to wirelessly communicate with other systems within an environment surrounding vehicle 100. By way of example, and not limitation, receiver 105 may be operable to receive wireless data communications from other vehicles, infrastructure data sources, or other objects within sufficient proximity that communication is possible, such as personal computers, smart phones, or other objects known to one of ordinary skill to have wireless communication capabilities. By way of example, and not limitation, transmitter 107 may he operable to transmit wireless data communications to other vehicles, infrastructure data sources, or other objects within sufficient proximity that communication is possible, such as personal computers, smart phones, or other objects known to one of ordinary skill to have wireless communication capabilities. Receiver 105 and transmitter 107 may he configured to communicate wirelessly via one or more of an RE (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In some embodiments, receiver 105 and transmitter 107 may be embodied as a single transceiver without deviating from the teachings disclosed herein. Some embodiments may not comprise transmitter 107 without deviating from the teachings disclosed herein.

Geolocation sensor 109 may he operable to detect a location of vehicle 100 utilizing an external positioning system, such as global positioning system (GPS), a different global navigation satellite system (GNSS), or other positioning system recognized by one of ordinary skill in the art. Geolocation sensor 109 may be operable to generate geolocation data describing the location of vehicle 100 with respect to the surrounding environment.

In some embodiments, vehicle 100 may comprise one or more autonomous driving functions useful to provide fully- or partially-autonomous control of the vehicle to processor 101. In such embodiments, processor 101 may be operable to utilize data generated by one or more of receiver 105, transmitter 107, or geolocation sensor 109 in conjunction with the autonomous driving functions to navigate vehicle 100 to a desired destination. Processor 101 may further be operable to generate assessment data describing an operating condition of vehicle 100. The assessment data may be generated in response to internal diagnostics of vehicle 100 operated by processor 101, based upon measurable conditions of vehicle 100 such as speedometer readings, odometer readings, fuel gauge readings, or reports from other internal systems of the vehicle. Vehicle 100 may be operable to generate data indicating conditions of vehicular systems pertaining to steering, braking, accelerating, maneuvering, operating temperatures, tire pressure, or any other condition known to one of ordinary skill in the art to be measurable using an internal diagnostic of a vehicle. In some embodiments, vehicle 100 may have systems suitable to generate a diagnostic trouble code (DTC) in response to data generated indicating particular operating conditions of vehicle 100. DTCs may be generated in response to indications that regular maintenance is appropriate, such as the vehicle having traveled a known distance since previous routine maintenance. DTCs may be generated in response to indications that one or more systems are performing sub-optimally. DTCs may be generated in response to indications that one or more systems may have experienced a fault condition.

Operating conditions may be derived from sources other than diagnostics. In some embodiments, operating conditions may comprise indications of desires or needs of passengers, such as requests for food, entertainment stops, tourism stops, shopping stops, or rest stops during travel. Other passenger-based operating conditions will be recognized by one of ordinary skill in the art without deviating from the teachings disclosed herein. Passenger-based operating conditions may be advantageous for embodiments of vehicle 100 operated using an autonomous function, wherein passengers may have reduced input in the control of the vehicle.

Vehicle 100 also comprises a human-machine interface (HMI) 111 within the chassis of the vehicle. HMI 111 may accommodate user interaction with processor 101 via audio, visual, or haptic input and output signals. In some embodiments, HMI 111 may comprise a touchscreen display with audio output functions, but other embodiments may comprise other configurations. In some embodiments, HMI 111 may comprise console controls, soft button controls, voice input, haptic response, a visual display, a dashboard indicator, or any other human input or output device recognized by one of ordinary skill in the art to accept user input without deviating from the teachings disclosed herein.

In the depicted embodiment, vehicle 100 comprises a privately-owned sedan, but other embodiments may comprise other configurations without deviating from the teachings disclosed herein. By way of example, and not limitation, vehicle 100 may comprise, a truck, compact car, sports car, luxury vehicle, van, minivan, motorcycle, limousine, taxi, private fleet vehicle, commercial fleet vehicle, commercial shipping vehicle, or any other suitable vehicle without deviating from the teachings disclosed herein.

The depicted embodiment, each of processor 101, memory 103, receiver 105, transmitter 107, and geolocation sensor 109 are depicted as being disposed within the chassis of vehicle 100, but other embodiment may comprise other configurations without deviating from the teachings disclosed herein. In some embodiments, processor 101 may comprise a distributed processing network to which elements of vehicle 100 may wirelessly communicate without deviating from the teachings disclosed herein. In some such embodiments, processor 101 may comprise a local processor disposed within or upon the chassis or interior or vehicle 100, with other processors accessible via wireless communication. Such distributed processing communication may be accomplished using receiver 105 and transmitter 107, or may utilize a separate component, such as a cellular modem, without deviating from the teachings disclosed herein. In some embodiments, memory 103 may be partially or completely disposed outside of the chassis of vehicle 100 without deviating from the teachings disclosed herein.

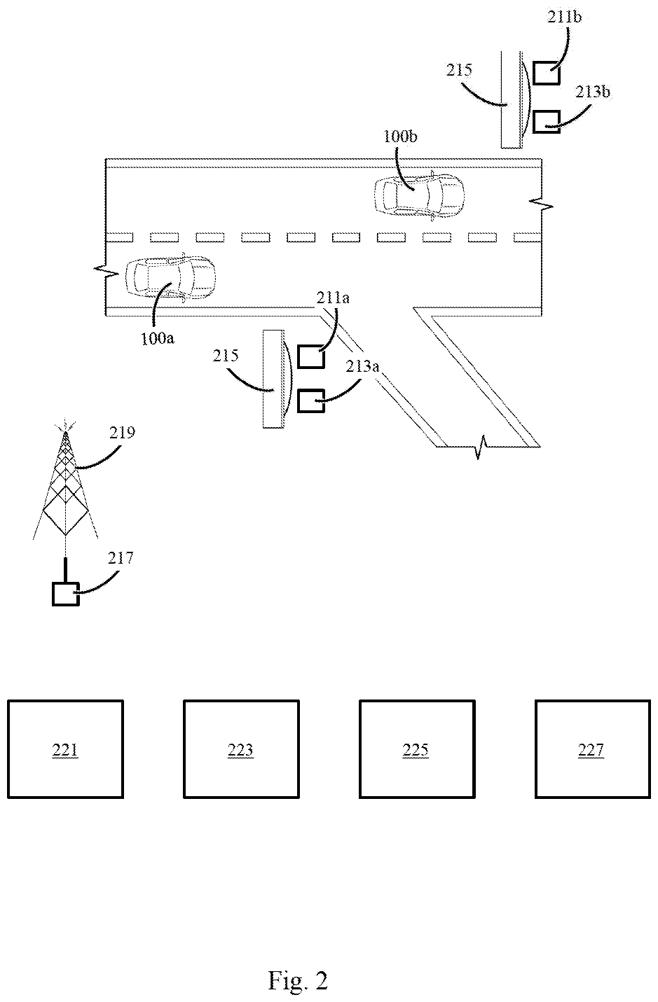

The vehicle telematics system of FIG. 1 may he operating within the context of a larger telematics network. FIG. 2 illustrates an exemplary embodiment of vehicles 100 operating within the context of a broader network. In the depicted embodiment, vehicles 100 are traveling along a roadway that comprises a number of infrastructure communication elements. In the depicted embodiment, infrastructure communication elements comprise a number of infrastructure transmitters 211 and a number of infrastructure receivers 213. Each of vehicles 100 may be operable to utilize its respective receiver 105 (see FIG. 1) to receive infrastructure communications wirelessly from infrastructure data sources, such as infrastructure transmitters 211 when within a specified wireless range. Infrastructure transmitters 211 may provide infrastructure communications to vehicles 100 automatically when the vehicles enter within proximity of the specified wireless range. In some embodiments, the infrastructure transmitters 211 may initiate two-way data communication with vehicles 100 by transmitting a “handshake” signal, or similar initiation signal indicating to the vehicle that transmission is incoming. Other embodiments may utilize an automatic connection of the vehicle 100 to the infrastructure transmitter when the vehicle is within proximity of the specified wireless range.

Each of vehicles 100 may be operable to utilize its respective transmitter 107 (see FIG. 1) to transmit vehicle communications to infrastructure receivers 213 when within the specified wireless range. Infrastructure receivers 213 may receive vehicle communications from vehicles 100 automatically when the vehicles enter within proximity of the specified wireless range. In some embodiments, the transmitters 107 (see FIG. 1) may initiate two-way data communication with infrastructure receivers 213 by transmitting a “handshake” signal, or similar initiation signal indicating to the vehicle that transmission is incoming. Other embodiments may utilize an automatic connection of the vehicle 100 to the infrastructure receiver when the vehicle is within proximity of the specified wireless range.

In the depicted embodiment, the infrastructure communication elements are embodied within signage 215, but other embodiments may comprise other configurations. Infrastructure communication elements may be embodied in other elements of roadway infrastructure, such as overpasses, street lights, buildings or roadways. Infrastructure communication elements may also be embodied as standalone elements without deviating from the teachings disclosed herein. In the depicted embodiment, infrastructure communication elements are depicted as separate transmitter and receivers, but other embodiments may comprise unified transceivers capable of both sending and receiving wireless data without deviating from the teachings disclosed herein. In some embodiments, different infrastructure communication elements may comprise different configurations, such as unified transceivers used in some instances and separate transmitter/receiver configurations used in other instances of the same network.

In the depicted example embodiment, vehicle 100a is within proximity of wireless communication with infrastructure transmitter 211a and infrastructure receiver 213a, but not within. proximity of infrastructure transmitter 211b and infrastructure receiver 213b. In contrast, vehicle 100b is within proximity of all depicted infrastructure communication elements and may interact with all of them wirelessly. Each of the infrastructure communication elements may be in wireless communication with a server 217, via a server transceiver 219. Server 217 may provide information on a number of assets within a local proximity of particular ones of the communication elements. Assets may comprise vendors of goods or services, or other points of interest that may be desired for a vehicle or passengers of a vehicle during travel. In the depicted embodiment, server 217 may comprise information pertaining to assets such as a maintenance shop 221, an automotive supplier 223, a rest area 225, and restaurant 227. Other examples of assets may comprise fueling stations, recharging stations, lodging, parking, shopping centers, museums, amusement parks, tourist attractions, sports facilities, libraries, or any other provider of goods or services recognized to one of ordinary skill in the art. In some embodiments, an asset may comprise a legally-mandated transaction, such as a weigh station for a commercial shipping vehicle, or a tollway booth. In some embodiments, an asset may comprise a roadside stopping location that may be utilized in the event of an emergency stop.

Though the depicted embodiment comprises a server 217 as a go-between infrastructure communication elements and nearby assets, some embodiments may be configured such that one or more of the assets is in direct communication with the nearby infrastructure communication elements without deviating from the teachings disclosed herein. In some embodiments, a hybrid configuration may utilize a server for some assets, but direct communication for other assets. Infrastructure communications from the infrastructure communication elements may comprise business or operating information about the nearby assets. Business or operating information may comprise static information or dynamic information. Static information may comprise information about the asset that is not time-sensitive, such as the address or geolocation of the asset, directions to navigate a vehicle to the asset from the location of the infrastructure communication element, total available parking, a list of services provided by the asset, a categorization of the asset, or other unchanging information recognized by one of ordinary skill without deviating from the teachings disclosed herein. Dynamic information may comprise information about the asset that may be time-sensitive, such as business hours, the current operating status of the asset, any current and ongoing promotional offers (such as specials, sales, or discounts), the current inventory status of a vendor of goods, the current parking spaces available at the asset, current vacancy of a lodging asset, current availability of services, current wait times for service, current pricing of goods or services, or any other information that may change with respect to the current time without deviating from the teachings disclosed herein. The infrastructure information may comprise a listing of available transactions at an asset based upon the static information and the dynamic information. In some embodiments, some assets may provide different information without deviating from the teachings disclosed herein. In some embodiments, some assets may only provide static information without deviating from the teachings disclosed herein.

In some embodiments, a vehicle may maintain a record comprising a history of vehicle communications, infrastructure communications, assessment data, geolocation data, and operations of the vehicle. In some embodiments, the record may be stored locally on the vehicle, such as in memory 103 (see FIG. 1), but other embodiments may comprise other configurations, such as a cloud-based storage, without deviating from the teachings disclosed herein. A processor associated with the vehicle, such as processor 101 (see FIG. 1), may utilize the record and assessment data of the operating condition of the vehicle to predict a desired transaction or other operation of the vehicle. As the system is utilized over time, the preferences of passengers may be predicted with greater accuracy. For example, if a passenger of the vehicle prefers to refuel the vehicle when the fuel gauge is at 25% of total capacity, the associated processor may recognize this behavior and recommend fuel be sought when a nearby asset offers fuel and the fuel gauge is approaching 25%. In some embodiments, passengers may provide user input to establish preferences for common transactions pertaining to the vehicle.

In the depicted embodiment, vehicle 100a may be experiencing a DTC indicating a fault condition of a headlight. Upon achieving proximity with infrastructure communication elements 211a and 213a, a vehicle communication may be transmitted indicating the need for servicing. Processor 101 (see FIG. 1) of vehicle 100a may consult the record of past communications and operations to determine a request be made to server 217 for data based upon demonstrated passenger preferences. If the passenger has demonstrated a preference for professional repairs, a transaction with maintenance shop 221 may be recommended. If the passenger has demonstrated a preference for self-repair, a transaction to purchase the necessary parts at automotive supplier 223 may be recommended. This recommendation may be modified by processor 101 in response to conditions presented in the static data or dynamic data provided by the server 217. For example, a transaction at maintenance shop 221 may be recommended even if the passenger prefers self-repair if automotive supplier 223 is not suitable. Instances wherein automotive supplier 223 may not be suitable may comprise the necessary parts not being within stock, or the automotive supplier 223 being currently closed for business. Other information may be utilized to arrive at such a decision, such as the overall price of repair at the maintenance shop 221 being lower than the parts available at automotive supplier 223, or the automotive supplier 223 being further than a threshold distance from the current position of vehicle 100a, or simply further than maintenance shop 221.

In some embodiments, desired transactions may be formulated based upon assessment, data generated in response to passenger input to the vehicle. For example, a transaction at rest area 225 or restaurant 227 may be suggested in response to a passenger request for a rest stop. Restaurant 227 may be suggested if, for example, it is, closer to the current location of the vehicle or the passenger also input a request for food. By way of example, and not limitation, in the depicted embodiment, vehicle 100b may be operating under a request from a passenger for a specific kind of food. If that food cannot be found at any of the assets nearby, vehicle 100b may continue traveling until such time that an asset is found that has the specific kind of food available. In some embodiments, if a passenger request goes unfulfilled for a specified length of time or distance of travel, the vehicle may provide a prompt to the user via HMI 111 (see FIG. 1) requesting confirmation of the initial request or providing an alternative transaction.

In some embodiments, a vehicle having an autonomous function may utilize the autonomous functions and geolocation data to automatically navigate the vehicle toward a particular asset. Such automatic navigation may be utilized in the event that operation of the vehicle is not sustainable without intervention, such as the vehicle running out of fuel or experiencing a critical operational error that renders continued operation unsafe for the passengers.

Other embodiments may comprise other predictions in response to received information about nearby assets, passenger preferences, and assessment data of the operating condition. of the vehicle without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicle telematics system comprising:
a processor associated with a vehicle and operable to generate assessment data describing an operating condition of the vehicle;
a memory in data communication with the processor; and
a receiver at least partially disposed within a first specified proximity of the vehicle and in data communication with the processor, the receiver operable to receive an infrastructure communication wirelessly from an infrastructure data source within a second specified proximity of the receiver, the second specified proximity being larger than the first specified proximity,
wherein the infrastructure communication is transmitted wirelessly, wherein the infrastructure communication describes an available transaction from a vendor, wherein the memory is configured to store a record comprising a history of infrastructure communications, and wherein the processor is operable to predict a desired transaction based upon the record and the assessment data.

2. The vehicle telematics system of claim 1, further comprising a transmitter at least partially disposed within the first specified proximity of the vehicle and in data communication with the processor, the transmitter operable to wirelessly transmit a vehicle communication to an infrastructure data receiver within the second specified proximity of the transmitter, wherein the vehicle communication describes a desired transaction for a passenger of the vehicle, and wherein the record further includes a history of vehicle communications.

3. The vehicle telematics system of claim 2, wherein the vehicle communication comprises a diagnostic trouble code (DTC).

4. The vehicle telematics system of claim 1, wherein the infrastructure communication comprises business information about a business within a third proximity of the infrastructure data source.

5. The vehicle telematics system of claim 4, wherein the business information includes at least two of operating hours, current operating status, current inventory status, and current promotional offers.

6. The vehicle telematics system of claim 1, further comprising a geolocation sensor in data communication with the processor, the geolocation sensor operable to measure geolocation data describing a location of the vehicle with respect to the surrounding environment.

7. The vehicle telematics system of claim 6, wherein the vehicle comprises an autonomous function and wherein the processor is operable to utilize the geolocation sensor and the autonomous function to navigate the vehicle to a specified destination.

8. The vehicle telematics system of claim 1, further comprising a human-machine interface associated with the vehicle operable to accept input from a passenger and present information to a passenger, wherein a vehicle communication is generated in response to user input.

9. The vehicle telematics system of claim 8, wherein the human-machine interface comprises a touchscreen display disposed within a console of the vehicle.

10. A vehicle telematics system comprising:
a vehicle;
a processor associated with the vehicle and operable to generate assessment data describing an operating condition of the vehicle;
a memory in data communication with the processor;
a receiver at least partially disposed within a first specified proximity of the vehicle and in data communication with the processor, the receiver operable to receive an infrastructure communication wirelessly from an infrastructure data source within a second specified proximity of the receiver, the second specified proximity being larger than the first specified proximity; and
a transmitter at least partially disposed within the first specified proximity of the vehicle and in data communication with the processor, the transmitter operable to wirelessly transmit a vehicle communication to an infrastructure data receiver within the second specified proximity of the transmitter,
wherein the infrastructure communication and the vehicle communication are transmitted wirelessly, wherein the vehicle communication describes a desired transaction for a passenger of the vehicle, wherein the infrastructure communication describes an available transaction from a vendor, wherein the memory is configured to store a record comprising a history of infrastructure communications and a history of vehicle communications, and wherein the processor is operable to predict a desired transaction based upon the record and the assessment data.

11. The vehicle telematics system of claim 10, wherein the vehicle communication comprises a diagnostic trouble code (DTC).

12. The vehicle telematics system of claim 10, wherein the infrastructure communication comprises business information about a business within a third proximity of the infrastructure data source.

13. The vehicle telematics system of claim 12, wherein the business information includes at least two of: operating hours, current operating status, current inventory status, and current promotional offers.

14. The vehicle telematics system of claim 10, further comprising a geolocation sensor in data communication with the processor, the geolocation sensor operable to measure geolocation data describing a location of the vehicle with respect to the surrounding environment.

15. The vehicle telematics system of claim 14, wherein the vehicle comprises an autonomous function and wherein the processor is operable to utilize the geolocation sensor and the autonomous function to navigate the vehicle to a specified destination.

16. The vehicle telematics system of claim 10, further comprising a human-machine interface associated with the vehicle and operable to accept input from a passenger and present information to a passenger, wherein the vehicle communication is generated in response to user input.

17. The vehicle telematics system of claim 16, wherein the human-machine interface comprises a touchscreen display disposed within a console of the vehicle.

18. A vehicle telematics system comprising:
a processor associated with a vehicle having an autonomous function and operable to generate assessment data describing an operating condition of the vehicle;
a memory in data communication with the processor;
a geolocation sensor in data communication with the processor, the geolocation sensor operable to measure geolocation data describing a location of the vehicle with respect to the surrounding environment;
a receiver at least partially disposed within a first specified proximity of the vehicle and in data communication with the processor, the receiver operable to receive an infrastructure communication wirelessly from an infrastructure data source within a second specified proximity of the receiver, the second specified proximity being larger than the first specified proximity; and
a transmitter at least partially disposed within the first specified proximity of the vehicle and in data communication with the processor, the transmitter operable to wirelessly transmit a vehicle communication to an infrastructure data receiver within the second specified proximity of the transmitter,
wherein the infrastructure communication and the vehicle communication are transmitted wirelessly, wherein the vehicle communication is generated in response to assessment data, wherein the infrastructure communication describes an available transaction from a vendor, wherein the memory is configured to store a record comprising a history of infrastructure communications and a history of vehicle communications, and wherein the processor is operable to navigate the vehicle to a specified destination using the autonomous function and the geolocation data in response to the infrastructure communication and the assessment data.

19. The vehicle telematics system of claim 18, wherein the infrastructure communication comprises business information that includes at least two of: operating hours, current operating status, current inventory status, and current promotional offers.

20. The vehicle telematics system of claim 18, further comprising a human-machine interface associated with the vehicle and operable to accept input from a passenger and present information to a passenger, wherein the vehicle communication is generated in response to user input.
